(19) United States
(12) Patent Application Publication
(10) Pub. No.: US 2009/0056761 A1
(43) Pub. Date: Mar. 5, 2009

(54) APPARATUS FOR MAINTAINING A CLEAN BONDING ENVIROMENT

(76) Inventors: Po Lam Benny AU, Hong Kong (HK); Jonathan Charles MASTERS, Hong Kong (HK); Wing Chiu Derek LAI, Hong Kong (HK); Tak Wai Rick LAW, Hong Kong (HK); Ming Lok Benjamin YEUNG, Hong Kong (HK); Kei Him Davy LAU, Hong Kong (HK)

Correspondence Address: OSTROLENK FABER GERB & SOFFEN, 1180 AVENUE OF THE AMERICAS, NEW YORK, NY, 100368403, US

(21) Appl. No.: 11/846,241

(22) Filed: Aug. 28, 2007

(51) Int. Cl. B08B 5/04; B05C 5/02

(52) U.S. Cl. 134/21; 156/389

(57) ABSTRACT

A bonding apparatus for bonding materials onto a substrate supported on a substrate support is provided with an air generator that is arranged and configured to direct an air flow onto the substrate during bonding. The air generator is located on one side of the substrate support, whereas a suction device is located on an opposite side of the substrate support which is operative to draw the air flow away from the bonding apparatus. The air generator further comprises an air knife that is operative to generate a unidirectional air flow over an entire length of the substrate during bonding.

### FIELD OF THE INVENTION

The present invention relates to an apparatus for providing a contamination-free environment, and in particular, to an apparatus for providing a clean environment during bonding of electronic devices.

### BACKGROUND AND PRIOR ART

In the electronics industry, it is often highly crucial to provide a working area with a substantially clean environment that is free from foreign particles. This is especially significant in processes relating to camera module production. For example, the presence of a tiny speck of foreign particle on an image sensor of a camera is likely to block the active sensing pixels on the image sensor and to create dark spots on the images produced. It is therefore important to provide a particle-free process chamber for working with sensitive image sensors to eliminate particles adhering onto the sensors. In particular, it is important to create a particle-free process chamber when bonding a chip such as an image sensor onto a substrate.

Conventional methods of removing particles from the substrate include using an air blower in the form of a fan or a nozzle. Ionized air may also be generated to discharge electrostatic charges that are on the substrate, or otherwise particles may be attracted to the charged substrate. Moving air that is blown from the fan or nozzle lifts and carries foreign particles away from the surface of the substrate before an image sensor is bonded onto it.

However, there are disadvantages in the conventional methods. A fan blower produces a turbulent air flow such that the particles that are blown off from the surface of the substrate cannot be collected and removed easily. These particles circulate in the process chamber and may re-settle on the substrate or rest on neighbouring substrates. As a result, the process chamber will remain contaminated with foreign particles. On the other hand, a nozzle blower targets only a small area of the substrate each time such that the process of removing the particles is very slow and inefficient.

Another method for maintaining a clean bonding environment is disclosed in Japanese patent publication number 2006-080132. In this prior art, a blower is provided to produce an air current so that no dust may contaminate a substrate such as a circuit member to be bonded. In addition, a cover member is provided between a bonding head and the circuit member so that the circuit member may not be displaced from the circuit member holding support when the air current is blown against the circuit member. A disadvantage of this approach is that a cover has to be used that prevents air flow onto the circuit members and thus prevents foreign particles from being dislodged from the circuit members. The blower also tends to produce a turbulent air current. By generating the air flow in the feeding direction of the circuit members, there is a further problem that particles may blown onto other parts of the device rather than being totally removed from the bonding system. Another shortcoming is that a suction machine for attracting the air current and particles carried by it is elevated and arranged at the same level as the blower. As a result, there is a possibility that large particles may not be as easily attracted by the suction machine, and may instead drop onto the circuit members. Hence, it would be desirable to develop an improved particle removal apparatus which is able to overcome some of the above shortcomings of the prior art.

### SUMMARY OF THE INVENTION

It is thus an object of this invention to seek to provide an apparatus for obtaining a contamination-free environment for use when bonding electronic devices such as image sensors to substrates, so that the bonded components are substantially free from contaminants.

According to a first aspect of the invention, there is provided a bonding apparatus for bonding materials onto a substrate, comprising: a substrate support for supporting the substrate during bonding; an air generator located on one side of the substrate support that is arranged and configured to direct an air flow onto the substrate; and a suction device located on an opposite side of the substrate support for drawing the air flow away from the bonding apparatus; wherein the air generator comprises an air knife that is operative to generate a unidirectional air flow over an entire length of the substrate during bonding.

According to a second aspect of the invention, there is provided a method of maintaining a clean environment when bonding materials onto a substrate, comprising: providing a substrate support for supporting the substrate during bonding; directing an air flow onto the substrate using an air generator located on one side of the substrate support; and drawing the air flow away from the substrate using a suction device located on an opposite side of the substrate support; wherein the air generator comprises an air knife that is operative to generate a unidirectional air flow over an entire length of the substrate during bonding.

It would be convenient hereinafter to describe the invention in greater detail by reference to the accompanying drawings which illustrate one preferred embodiment of the invention. The particularity of the drawings and the related description is not to be understood as superseding the generality of the broad identification of the invention as defined by the claims.

### BRIEF DESCRIPTION OF THE DRAWINGS

The present invention will be readily appreciated by reference to the detailed description of one preferred embodiment of the invention when considered with the accompanying drawings, in which:

FIG. 1 is an isometric view of a work holder of a bonding system incorporating an apparatus for maintaining a clean bonding environment according to the preferred embodiment of the invention;

FIG. 2 is a sectional side view of the apparatus looking from line A-A of FIG. 1; and

FIG. 3 is a cross-sectional view of an air knife assembly according to the preferred embodiment of the invention.

### DETAILED DESCRIPTION OF THE PREFERRED EMBODIMENT OF THE INVENTION

The preferred embodiment of the present invention will be described hereinafter with reference to the accompanying drawings.

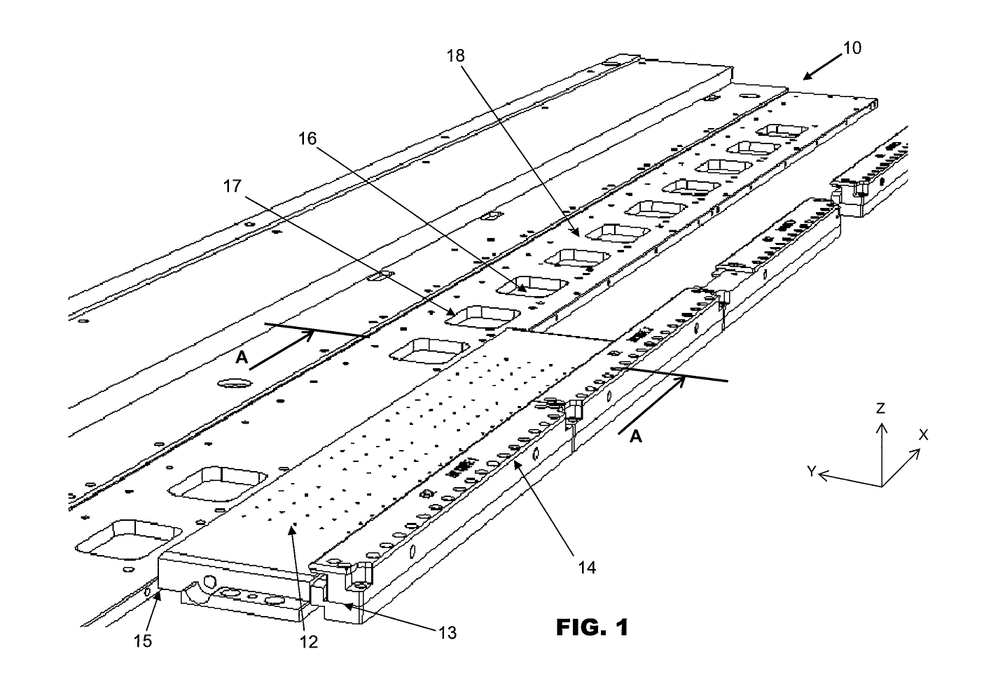

FIG. 1 is an isometric view of a work holder of a bonding system 10 incorporating an apparatus for maintaining a clean bonding environment according to the preferred embodiment of the invention.

The work holder comprises a substrate support 12 mounted on two tracks 13, 15 with each track carrying a length of the substrate support 12. The tracks 13, 15 are arranged parallel to a feeding direction of the substrate for bonding. The substrate support 12 is utilized for supporting the substrate during bonding and the substrate is movable on the tracks 13, 15 when it is held by an indexer 18 and moved. Mounted on or adjacent to a first track 13 is an air generator, such as an air knife comprising a plurality of air knife assemblies 14 along the length of the track 13, while the second track 15 on the opposite side of the substrate support 12 is coupled to the indexer 18. Preferably, the air knife assemblies 14 are operative to generate a unidirectional air flow over an entire length of the substrate during bonding, and more preferably, are substantially coextensive with an entire length of the first track 13.

Located adjacent to the second track 15 is a suction device, which may comprise a plurality of openings 17 on its top surface leading downwards to a plurality of exhaust fans 16. The openings 17 are preferably located beneath the air flow and are operative to allow the suction device to draw the air flow from the bonding system 10 in a direction that is perpendicular to the air flow direction. The exhaust fans 16 generate a suction force to draw and remove air that is flowing over the substrates from the bonding system 10. In this way, the air flow carrying impurities in the process chamber can be removed from the chamber efficiently as larger particles that are less easily lifted by blowing may fall into the exhaust fans 16 by the weight of gravity.

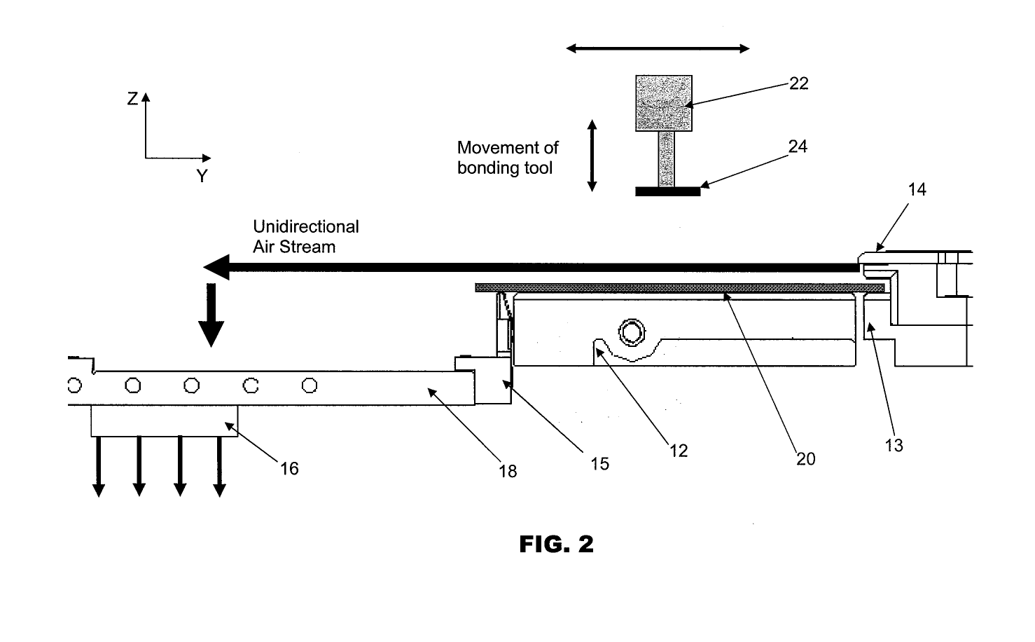

FIG. 2 is a sectional side view of the apparatus looking from line A-A of FIG. 1. A bonding tool 22 is primarily movable in the Y and Z axes and is positioned above a substrate 20 which is placed onto a substrate support 12 in the process chamber. Before a bonding material, such as an image sensor 24, is attached onto the substrate 20 by the bonding tool 22, the plurality of air knife assemblies 14 direct an evenly distributed sheet of clean unidirectional ionized air across the entire surface of the substrate 20. This air flow lifts and carries impurities away from the substrate 20 to provide a clean surface for attaching the image sensor 24.

It is also noted from FIGS. 1 and 2 that the direction of the unidirectional air flow (along the Y-axis) is transverse to the direction of travel of the substrate 20 on the substrate support 12 (along the X-axis). This helps to ensure that foreign particles are removed from the bonding area and not simply blown from one part of the substrate to another, or to another substrate. Additionally, as the air is preferably ionized, electrostatic charges on the surfaces of the substrate 20 and the image sensor 24 can be dislodged. This prevents impurities from adhering to the said surfaces in the process chamber.

The air knife assemblies 14 are operative to generate a high velocity air flow to blow particles off the substrate 20 since the ionized air current flows directly onto and across the substrate 20. Furthermore, the air stream forms a curtain of air over the processed substrate 20 to prevent particles from re-settling onto the same or neighbouring process substrates. The air knife assemblies 14 are preferably adjustable such that the air flow is either directed horizontally or inclined at different angles with respect to the horizontal to achieve the desired performance. This removal of foreign particles from the bonding system 10 is further aided by the plurality of exhaust fans 16 found under the openings 17 of the suction device which provides an active suction force that immediately absorbs foreign particles that have been blown off from the processed substrates 20. Moreover, particles that are generated when the substrate 20 is being transported on the substrate support 12 are also being blown off and removed by the high velocity stream of air from the processing unit. Thus, an isolated process chamber with a contaminant-free environment is created for bonding the image sensor to a substrate.

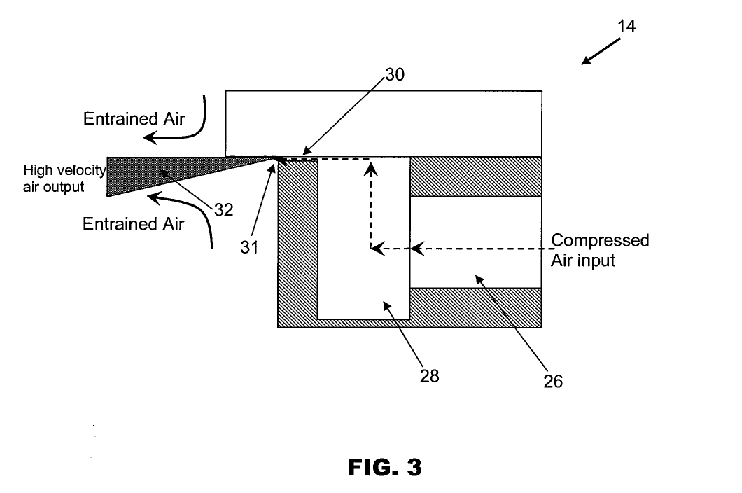

FIG. 3 is a cross-sectional view of an air knife assembly 14 according to the preferred embodiment of the invention. This view shows the directions of the air flows introduced into and generated out of the air knife assembly 14. An input of air at high pressure is forced into a chamber 26 which is next channeled into an air reservoir 28 before emerging over the processing unit through a conduit 30. The conduit 30 comprises a narrow elongated channel so that the flow of air from the air reservoir 28 emerges from the channel as a high intensity, balanced sheet of unidirectional air flow. The air flow is preferably generated at a sufficiently high velocity so as to entrain air from the surrounding atmosphere adjacent to the conduit 30 into the air flow. An advantage of the air flow so produced is that it is further amplified by being combined with atmospheric air that is entrained due to the higher pressure generated at an outlet 31 of the conduit 30. An even unidirectional thin sheet of air that is produced at high velocity is therefore generated which, unlike the turbulent air flow by a conventional fan blower, quickly removes impurities from the process chamber in a single direction so that the impurities do not remain and resettle in the chamber.

Since the plurality of air knife assemblies 14 is positioned adjacent the substrate support 12 to generate an even sheet of high velocity air flow over the whole of the processed substrate, foreign particles are effectively removed from the process chamber in the direction of the indexer 18 swiftly and effectively.

It should be appreciated that the apparatus for maintaining a clean bonding environment according to the preferred embodiment of the invention provides various advantages. First, the high velocity sheet of air carries away particles from the surfaces of the processing unit in one direction and exit the process chamber via the exhaust fans 16 in a direction away from the processed substrates 20. The air flow also forms an air curtain preventing foreign particles from falling onto the processing units without the need for introducing an extraneous cover. Thus, the foreign particles are unable to resettle onto the processed substrates 20. The sheet of air generated also flows over the entire length of the processed substrate which speeds up the process of sweeping off impurities from the working surface. Moreover, the ionized air flow discharge electrostatic charges in the process chamber which reduces the chance of particles being attracted to the charged substrates. Therefore, a clean contamination-free processing environment can be achieved that is suitable for processing image sensors.

Further, the apparatus actively blows the amplified air directly onto the substrate 20 to ensure that incoming particles present on the substrate or bonding material (image sensor) are removed before bonding is completed, as well as remove particles carried by the bond head, dispensing system and clamping devices. The air flow also removes particles that have adhered onto the substrate 20 when it is being transported onto the workholder. Directing the amplified air in a direction that is transverse to the feeding direction has an added advantage that foreign particles which have been generated when bonding previous devices will not be carried forward to the bonding of subsequent devices as the foreign particles are totally dislodged from the substrate 20 more quickly.

The invention described herein is susceptible to variations, modifications and/or additions other than those specifically described and it is to be understood that the invention includes all such variations, modifications and/or additions which fall within the spirit and scope of the above description.

1. Bonding apparatus for bonding materials onto a substrate, comprising:
a substrate support for supporting the substrate during bonding;
an air generator located on one side of the substrate support that is arranged and configured to direct an air flow onto the substrate; and
a suction device located on an opposite side of the substrate support for drawing the air flow away from the bonding apparatus;
wherein the air generator comprises an air knife that is operative to generate a unidirectional air flow over an entire length of the substrate during bonding.

2. Bonding apparatus as claimed in claim 1, wherein the air generator is mounted adjacent a first track and the suction device is mounted adjacent to a second track respectively, the first and second tracks being arranged parallel to a feeding direction of the substrate for bonding and operative to guide feeding of the substrate.

3. Bonding apparatus as claimed in claim 2, wherein the suction device comprises a plurality of openings adjacent to the second track that are located underneath the air flow, and are operative to draw the air flow from the bonding apparatus in a direction that is perpendicular to the air flow direction.

4. Bonding apparatus as claimed in claim 1, wherein the suction device further comprises exhaust fans located under the openings.

5. Bonding apparatus as claimed in claim 1, wherein the air flow direction is transverse to a feeding direction of the substrate for bonding.

6. Bonding apparatus as claimed in claim 1, wherein the air knife comprises a narrow elongated conduit generating a high intensity, balanced sheet of unidirectional air flow at a sufficiently high velocity so as to entrain air from the surrounding atmosphere adjacent to the conduit into the air flow.

7. Bonding apparatus as claimed in claim 1, wherein the air flow is operative to form an air curtain over the substrate.

8. Bonding apparatus as claimed in claim 1, wherein the air knife is substantially coextensive with an entire length of the first track.

9. Bonding apparatus as claimed in claim 1, wherein the air flow comprises ionized air.

10. Method of maintaining a clean environment when bonding materials onto a substrate, comprising:
providing a substrate support for supporting the substrate during bonding;
directing an air flow onto the substrate using an air generator located on one side of the substrate support; and
drawing the air flow away from the substrate using a suction device located on an opposite side of the substrate support;
wherein the air generator comprises an air knife that is operative to generate a unidirectional air flow over an entire length of the substrate during bonding.

11. Method as claimed in claim 10, wherein the air generator is mounted adjacent a first track and the suction device is mounted adjacent to a second track respectively, the first and second tracks being arranged parallel to a feeding direction of the substrate for bonding and operative to guide feeding of the substrate.

12. Method as claimed in claim 11, wherein the suction device comprises a plurality of openings adjacent to the second track that are located underneath the air flow, and are operative to draw the air flow from the bonding apparatus in a direction that is perpendicular to the air flow direction.

13. Method as claimed in claim 10, wherein the suction device further comprises exhaust fans located under the openings.

14. Method as claimed in claim 10, wherein the air flow direction is transverse to a feeding direction of the substrate for bonding.

15. Method as claimed in claim 10, wherein the air knife comprises a narrow elongated conduit generating a high intensity, balanced sheet of unidirectional air flow at a sufficiently high velocity so as to entrain air from the surrounding atmosphere adjacent to the conduit into the air flow.

16. Method as claimed in claim 10, further comprising the step of generating an air curtain over the substrate with the air flow.

17. Method as claimed in claim 10, wherein the air knife is substantially coextensive with an entire length of the first track.

18. Method as claimed in claim 10, wherein the air flow comprises ionized air.
